(19) United States
(12) Patent Application Publication
(10) Pub. No.: US 2014/0240787 A1
(43) Pub. Date: Aug. 28, 2014

(54) Mechanism for Applying Marks After Rasterization

(71) Applicants: John Thomas Varga, Longmont, CO (US); David Ward, Broomfield, CO (US); Ioan Husanu, Deva (RO); Sebastian Vlad Tiponut, Timisoara (RO)

(72) Inventors: John Thomas Varga, Longmont, CO (US); David Ward, Broomfield, CO (US); Ioan Husanu, Deva (RO); Sebastian Vlad Tiponut, Timisoara (RO)

(21) Appl. No.: 13/780,095

(22) Filed: Feb. 28, 2013

(51) Int. Cl. G06K 15/02

(52) U.S. Cl. CPC G06K 15/1889
USPC 358/2.1; 358/1.15

(57) ABSTRACT

A method is disclosed. The method includes performing rasterization of print job data to generate a raster image, reading a job ticket associated with the print job data including marking data that is to be added to the raster image and performing a second rasterization to apply the marking data to the raster image.

### FIELD OF THE INVENTION

This invention relates generally to the field of printing systems. More particularly, the invention relates to image processing in a printing system.

### BACKGROUND

In a variety of document presentation systems such as printing systems, it is common to rasterize data to generate a bitmap representation of each sheetside image of the document by processing a sequence of data objects. The data objects are typically included in a print job that is defined in a page description language (PDL) or other suitable encoding that are, at some point prior to writing to a bitmap, represented as regions of rectangles of pixels. Typically, the sheetside image is generated into a bitmap memory as a two dimensional matrix of pixels representing the intended document sheetside image, and subsequently compressed. These sheetside images are often saved to enable reuse during printing of a job.

A job ticket may also be received as a component of the print job. The job ticket may be used to alter the print job, such as determine the addition of header and footer information, page numbering, crop marks, and applying watermarks. Conventionally, these alterations are applied at the time of rasterization to create a final version. However in such printing systems, the entire print job must be re-rasterized if the job ticket is edited sometime after rasterization, but before the job is forwarded to the printer's marking engine. Such re-rasterization is inefficient and time consuming.

Accordingly, a mechanism for applying marks after rasterization of a print job is desired.

### SUMMARY

In one embodiment, a method is disclosed. The method includes performing rasterization of print job data to generate a raster image, reading a job ticket associated with the print job data including marking data that is to be added to the raster image and performing a second rasterization to apply the marking data to the raster image

In another embodiment, a control unit is disclosed. The control includes a rasterizer to perform rasterization of print job data to generate a raster image and a marking engine to perform a second rasterization to apply additional marking data to the raster image.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 illustrates one embodiment of a control unit; and

FIG. 3 is a flow diagram illustrating one embodiment of a process for applying marks after rasterization of a print job; and

FIG. 4 illustrates one embodiment of a computer system.

### DETAILED DESCRIPTION

A mechanism for applying marks after rasterization of a print job is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

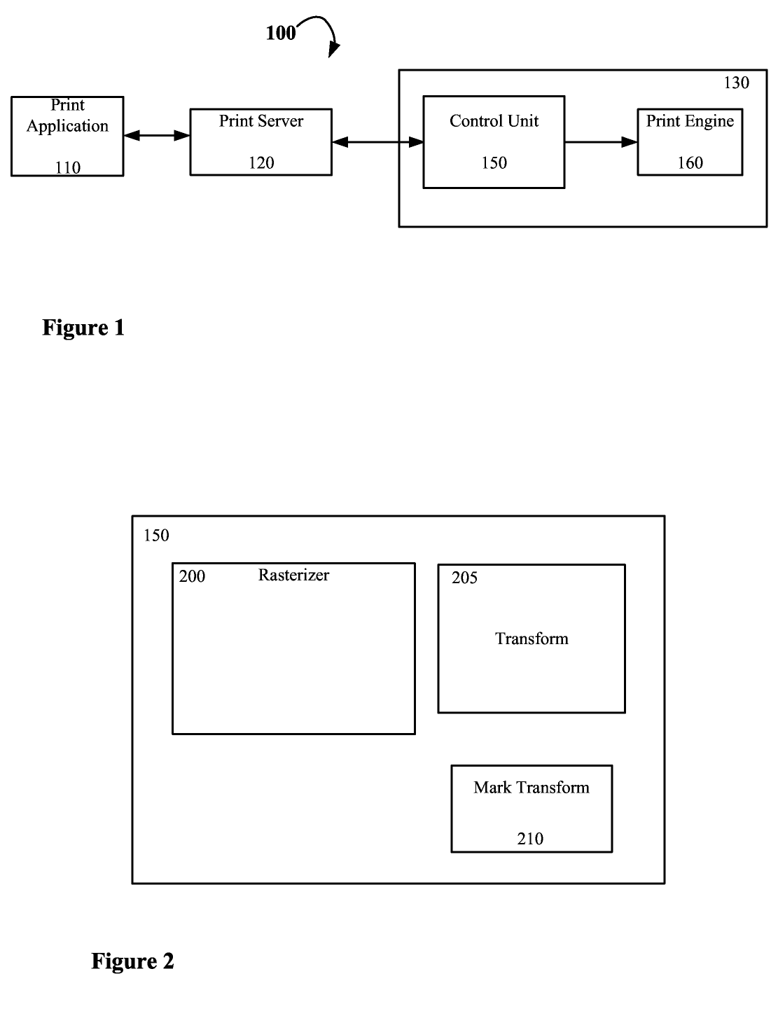

FIG. 1 illustrates one embodiment of a printing system 100. Printing system 100 includes a print application 110, a server 120 and printer 130. Print application 110 makes a request for the printing of a document. In one embodiment, print application 110 provides Advanced function printing (AFP) files for printing to print server 120. In a further embodiment, the print application provides PostScript (PS) and Portable Document Format (PDF) data streams to print server 108.

Printer 130 includes a control unit 150 and a print engine 160. According to one embodiment, control unit 150 performs processing functions for printer 130. In a further embodiment, control unit 150 processes and renders objects received from print server 120 and provides sheet maps for printing to print engine 160. Moreover, control unit 150 may include processing logic that may include hardware (e.g., circuitry, dedicated logic, programmable logic, microcode, etc.), software (such as instructions run on a processing device), or a combination thereof.

FIG. 2 illustrates one embodiment of a control unit 150. Control unit 150 includes a rasterizer 200 and PDF transform 205. Rasterizer 200 is implemented to process PDF pages received at control unit 150 by performing a raster image process (RIP) to convert a PDF described in a vector graphics format (e.g., shapes) into a raster image (e.g., pixels).

The RIP performed by rasterizer 200 produces a side map for each page of a print job that is ultimately forwarded to print engine 160 for printing. However as discussed above, a job ticket received with the print job may be edited, potentially making it necessary to perform a subsequent RIP of the same data to implement alterations to the print job as a result of the edit.

According to one embodiment, control unit 150 includes a mark transform 210 that is implemented to add editable data in the job ticket to the RIP data. In such an embodiment, editable data (e.g., header/footers, watermarks, color control bars, and crop marks) is withheld from the PDL data, and included only in the job ticket. Thus, the editable data is applied by mark transform 210 after the RIP is performed at rasterizer 200 (e.g., at print time) to allow a late binding to the final sheetside and to prevent the need to re-RIP the PDL job stream or file.

Mark transform 210 performs a process that generates marks from graphics and text and applies these marks to a sheetside via a marking interface used by a display list item. In one embodiment, mark transform 210 performs a lightweight RIP that uses XML instructions to specify positions, graphical elements and text. In such an embodiment, the elements are added to an area of the original RIP pages being rendered. Concurrently, the elements are scaled and positioned as they would be for the original page.

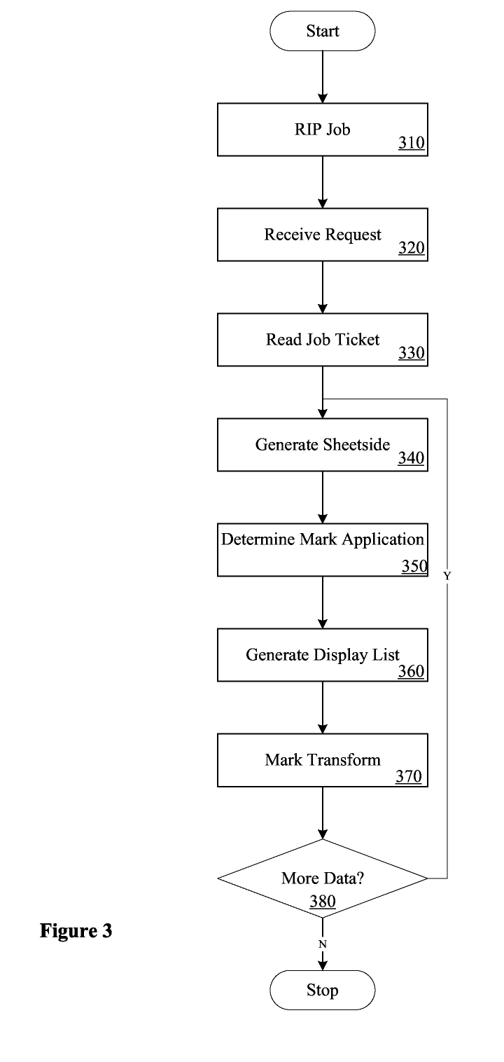

FIG. 3 is a flow diagram illustrating one embodiment of a process performed by control unit 150 to apply marks to a print job. At processing block 310, a RIP is performed on a page of the PDL data, as discussed above. At processing block 320, a request is received. In one embodiment, the request includes one or more file references that point to the print job RIP and references a current job ticket associated with the print job.

At processing block 330, the job ticket is read for marking data to be added to the print job. At processing block 340, the rasterized data is read to generate a sheetside. In one embodiment, the sheetside may include one page. However, a sheetside may include multiple pages (e.g., N-up format). At processing block 350, a locations to apply the marks to the sheetside are identified. In one embodiment, the process assembles the sheetside pages as bitmap references to be read from a RIP spool and generates mark commands to add rectangles for crop marks and color control bars atop the sheetside data. Moreover, the process may determine where lines are to be drawn, size of text, scaling of watermarks, etc.

At processing block 360, a display list is generated. In one embodiment, the display list enables the processing of headers, footers and watermarks that enable mark transform 210 to add text at the specified sizes, positions, and rotations. At processing block 370, mark transform 210 receives the display list and performs an additional rasterization to apply the marks to the sheetside as discussed above.

According to one embodiment, mark transform 210 writes text to the sidesheet and performing a clipping operation to clip the text to the original page boundaries of the original RIP pages. Further, mark transform 210 may perform blending of watermark data to the pages. At decision block 380 a determination is made as to whether the print job includes another page of RIP data that needs to be processed. If so, control is returned to processing block 340 where the next sheetside is generated. Otherwise, the process is completed.

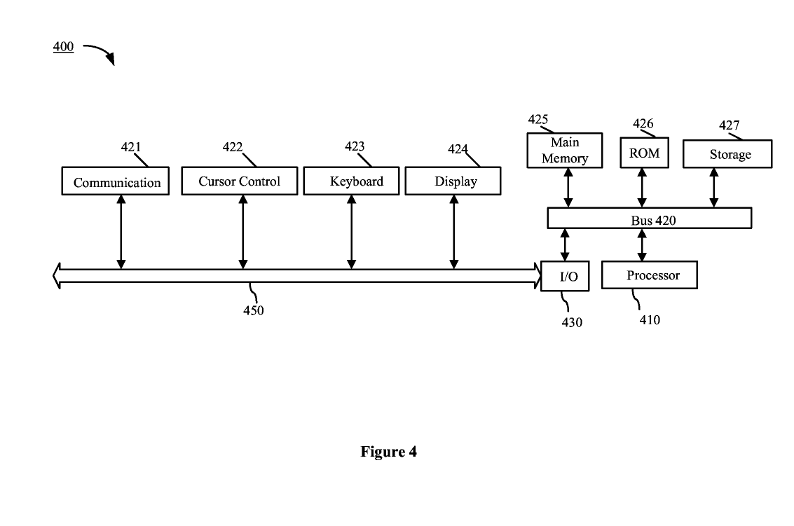

FIG. 4 illustrates a computer system 400 on which print server 120 and printer 130 described with respect to FIG. 1 may be implemented. Computer system 400 includes a system bus 420 for communicating information, and a processor 410 coupled to bus 420 for processing information. According to one embodiment, processor 410 is implemented using one of multitudes of microprocessors. Nevertheless one of ordinary skill in the art will appreciate that other processors may be used.

Computer system 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Computer system 400 also may include a read only memory (ROM) and or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424, an input device (e.g., an alphanumeric input device 423 and or a cursor control device 422). The communication device 421 is for accessing other computers (servers or clients) via an external data network, for example. The communication device 421 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. An article of manufacture comprising a computer-readable medium including instructions, which when executed by a processor, performs:
performing rasterization of print job data to generate a raster image;
reading a job ticket associated with the print job data including marking data that is to be added to the raster image; and
performing a second rasterization to apply the marking data to the raster image.

2. The article of manufacture of claim 1 comprising a computer-readable medium including instructions, which when executed by the processor, further performs receiving a request including one or more file references to the raster image and the job ticket prior to reading the job ticket.

3. The article of manufacture of claim 2 comprising a computer-readable medium including instructions, which when executed by the processor, further performs:
generating a sheetside of the raster image after reading the job ticket; and
identifying locations to apply the marks to the sheetside.

4. The article of manufacture of claim 3, wherein identifying locations to apply the marks to the sheetside comprises:
assembling the sheetside as bitmap references; and
generating mark commands to add rectangles for crop marks and color control bars atop the sheetside data.

5. The article of manufacture of claim 3 comprising a computer-readable medium including instructions, which when executed by the processor, further performs generating a display list.

6. The article of manufacture of claim 5, wherein performing the second rasterization comprises:
writing text to the sidesheet; and
performing a clipping operation to clip to the original page boundaries of the sheetside.

7. The article of manufacture of claim 6, wherein performing the second rasterization further comprises blending of watermark data to the sheetside.

8. The article of manufacture of claim 6, wherein the second rasterization is performed by a marking engine.

9. The article of manufacture of claim 8, wherein the marking engine generates marks from graphics and text and applies the marks to the sheetside via a marking interface used by an item in the display list.

10. The article of manufacture of claim 9, wherein the marking engine reads XML instructions that specify positions, graphical elements and text.

11. A control unit, comprising:
a rasterizer to perform rasterization of print job data to generate a raster image; and
a marking engine to perform a second rasterization to apply additional marking data to the raster image.

12. The control unit of claim 11, further comprising a component to read a job ticket associated with the print job including marking data that is to be added to the raster image.

13. The control unit of claim 12, further comprising a component to receive a request including one or more file references to the raster image and the job ticket prior to reading the job ticket.

14. The control unit of claim 13, further comprising:
a component to generate a sheetside of the raster image after reading the job ticket; and
a component to identify locations to apply the marks to the sheetside.

15. The control unit of claim 14, wherein identifying locations to apply the marks to the sheetside comprises assembling the sheetside as bitmap references and generating mark commands to add rectangles for crop marks and color control bars atop the sheetside data.

16. The control unit of claim 14, further comprising a component to generate a display list.

17. The control unit of claim 16, wherein the marking engine performs the second rasterization by writing text to the sidesheet and performing a clipping operation to clip to the original page boundaries of the sheetside.

18. The control unit of claim 17, wherein the marking engine further performs the second rasterization by blending of watermark data to the sheetside.

19. The control unit of claim 18, wherein the marking engine generates marks from graphics and text and applies the marks to the sheetside via a marking interface used by an item in the display list.

20. The control unit of claim 19, wherein the marking engine reads XML instructions that specify positions, graphical elements and text.
